(19) United States
(12) Patent Application Publication
(10) Pub. No.: US 2012/0195283 A1
(43) Pub. Date: Aug. 2, 2012

(54) METHOD FOR TRANSMITTING INFORMATION OVER A COMPONENT CARRIER IN A WIRELESS COMMUNICATION SYSTEM, AND WIRELESS COMMUNICATION SYSTEM

(75) Inventors: Kibum Kwon, Ansan-si (KR); Sungkwon Hong, Seoul (KR); Myungcheul Jung, Seoul (KR)

(73) Assignee: PANTECH CO., LTD., Seoul (KR)

(21) Appl. No.: 13/500,622

(22) PCT Filed: Sep. 16, 2010
(86) PCT No.: PCT/KR2010/006349

§ 371 Date: Apr. 5, 2012

(30) Foreign Application Priority Data
Oct. 6, 2009 (KR) 10-2009-0094862

(51) Int. Cl. H04W 72/04

(52) U.S. Cl. 370/329

(57) ABSTRACT

The present specification relates to a method for transmitting information over a component carrier and to a wireless communication system for the method. The present invention relates to a method for transmitting information that indicates an allocated component carrier, and to a method for transmitting information on the number of usable CCs of a terminal via upper layer signaling, and transmitting information on CC allocation via physical layer signaling.

### CROSS-REFERENCE TO RELATED APPLICATIONS

This application is the National Stage Entry of International Application No. PCT/KR2010/006349, filed on Sep. 16, 2010, and claims priority from and the benefit of Korean Patent Application No. 10-2009-0094862, filed on Oct. 6, 2009, both of which are incorporated herein by reference for all purposes as if fully set forth herein.

### BACKGROUND

1. Field

The present invention relates to a method of transmitting component carrier information and a wireless communication system for the method, and more particularly, to a method and a system for transmitting component carrier information through a separated signaling.

2. Discussion of the Background

One of the most important requirements of a next generation mobile communication system is a performance capable of supporting a requirement of a high data transmission rate.

The most fundamental and stable solution for the support of the requirement of a high data transmission rate is to increase a bandwidth.

However, current frequency resources are already saturated and various technologies have been used in a part of a broad frequency band.

### SUMMARY

Accordingly, the present invention has been made to solve the above-mentioned problems occurring in the prior art, and the present invention provides wireless communication technology capable of satisfying a requirement of a high data transmission rate.

Further, the present invention provides wireless communication technology capable of securing a transmission/reception broadband bandwidth in an uplink and a downlink.

Further, the present invention provides a method of transmitting component carrier information and a wireless communication system.

Further, the present invention provides a method of transmitting information on the number of usable CCs of a user equipment and information on CC allocation, and a wireless communication system.

Further, the present invention provides a method of transmitting information on the number of usable CCs of a user equipment and information on CC allocation through a separated signaling and a wireless communication system.

Further, the present invention provides a method of transmitting information on the number of usable CCs of a user equipment through an upper layer signaling and information on CC allocation through a physical layer signaling, and a wireless communication system.

Further, the present invention provides a method of transmitting information indicating an allocated component carrier and a wireless communication system.

In accordance with an aspect of the present invention, there is provided a method of transmitting Component Carrier (CC) information in a wireless communication system, the method including: transmitting information on a number of usable CCs of a user equipment to the user equipment, the information on the number of usable CCs being determined in a Radio Resource Control (RRC) layer; and inserting information on CC allocation in physical layer resource control information based on the information on the number of usable CCs of the user equipment and transmitting the information on the CC allocation to the user equipment.

In accordance with another aspect of the present invention, there is provided a method of transmitting Component Carrier (CC) information in a wireless communication system, the method including: determining information on a number of usable CCs of a user equipment and information on CC allocation for the user equipment considering the number of usable CCs by a scheduler; and inserting the determined information on the number of usable CCs and the determined information on the CC allocation in physical layer resource control information and transmitting the information on the number of usable CCs and the information on the CC allocation to the user equipment by the scheduler.

In accordance with another aspect of the present invention, there is provided a wireless communication apparatus including: a Radio Resource Control (RRC) layer for determining information on a number of usable CCs of a user equipment and transmitting the determined information on the number of usable CCs to the user equipment; and a physical layer for inserting information on CC allocation in physical layer resource control information based on the information on the number of usable CCs of the user equipment and transmitting the information on the CC allocation to the user equipment.

### BRIEF DESCRIPTION OF THE DRAWINGS

FIG. 1 is a block diagram illustrating a wireless communication system according to an embodiment of the present invention.

FIG. 2 is an enlarged conceptual diagram illustrating a frequency in a CA environment.

FIG. 3 is a layer diagram of a base station and a user equipment in a wireless communication system according to an embodiment of the present invention.

FIG. 4 is a flow diagram illustrating transmission of information on the number of usable CCs and information on actual CC allocation from a base station to a user equipment.

FIG. 5 is a flow chart illustrating a method of transmitting component carrier information according to another embodiment of the present invention.

FIG. 6 is a diagram illustrating sets of bit information and allocated CCs according to an embodiment of the present invention.

### DETAILED DESCRIPTION OF THE ILLUSTRATED EMBODIMENTS

Hereinafter, exemplary embodiments of the present invention will be described with reference to the accompanying drawings. In the following description, the same elements will be designated by the same reference numerals although they are shown in different drawings. Further, in the following description, a detailed explanation of known related functions and constitutions may be omitted so as to avoid unnecessarily obscuring the subject manner of the present invention.

Further, in describing the constructional elements of the present invention, the terms of a first, a second, A, B, (a), (b), or the like, can be used. Such a term is only for discriminating the constructional element from another constructional element, and does not limit the essential feature, order, or sequence of the constructional element, or the like. If one constructional element is “coupled to”, “assembled with”, or “connected to” another constructional element, one constructional element is directly coupled to or connected to another constructional element, but it can be understood as another different constructional element can be “coupled”, “assembled”, or “connected” between each constructional element.

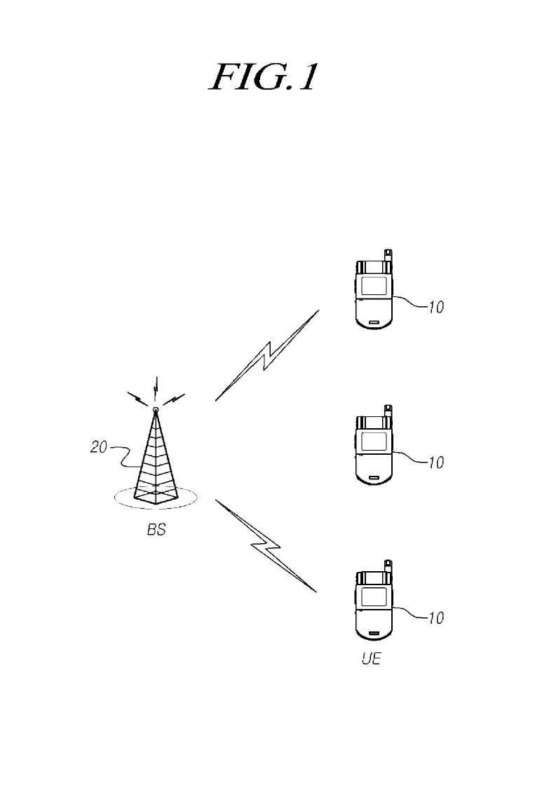

FIG. 1 is a block diagram illustrating a wireless communication system according to an embodiment of the present invention.

The wireless communication system is broadly disposed for providing various communication services, such as voice and packet data.

Referring to FIG. 1, the wireless communication system includes User Equipments (UEs) 10 and a Base Station (BS) 20. The UEs 10 and the BS 20 use various power allocation methods to be described below.

The UE 10 used herein has a general concept including a user's terminal in a wireless communication, and should be interpreted as a concept all including a Mobile Station (MS) in a Global System for Mobile Communication (GSM), a User Terminal (UT), a Subscriber Station (SS), and a wireless device, as well as UEs in Wide Code Division Multiple Access (WCDMA), Long-Term Evolution (LTE), and High Speed Packet Access (HSPA).

The BS 20 or a cell generally refers to a fixed station communicating with the UE 10, and may be called different terms, such as a Node-B, an evolved Node-B (eNB), a Base Transceiver System (BTS), and an Access Point (AP).

That is, the BS 20 or the cell used herein should be interpreted to have a general meaning indicating a partial area covered by a Base Station Controller (BSC) in the CPMA, a Node-B in the WCDMA, etc., and have a meaning generally including all various coverage areas, such as a mega cell, a macro cell, a micro cell, a pico cell, and a femto cell.

The UE 10 and the BS 20 used herein mean two general types of transmission/reception subjects used for implementation of a technique or a technical spirit described in the present specification, and they are not limited by a specifically designated term or word.

There is no limit in the multiple access methods applicable to the wireless communication system. That is, the wireless communication system may various multiple access methods, such as CDMA (Code Division Multiple Access), TDMA (Time Division Multiple Access), FDMA (Frequency Division Multiple Access), OFDMA (Orthogonal Frequency Division Multiple Access), OFDM-FDMA, OFDM-TDMA, and OFDM-CDMA.

Uplink transmission and downlink transmission may employ a Time Division Duplex (TDD) method of transmitting data by using different times or a Frequency Division Duplex (FDD) method of transmitting data by using different frequencies.

The embodiment of the present invention may be applied to resource allocation in an asynchronous wireless communication field evolved to the LTE and the LTE-advance from the GSM, the WCDMA, and the HSPA and a synchronous wireless communication field evolved to the CDMA-2000 and the Ultra Mobile Broadband (UMB). The present invention is not limited to a specific wireless communication field and should be interpreted to include all technical fields to which the spirit of the present invention may be applied.

One of the most important requirements of a next-generation mobile communication system is a performance capable of supporting a requirement of a high data transmission rate. To this end, various technologies including a Multiple Input Multiple Output (MIMO) method, a Cooperative Multiple Point (CoMP) transmission method, and a relay method have been researched, but the most fundamental and stable solution is to increase a bandwidth.

However, current frequency resources are already saturated and various technologies have been used in a part of a broad frequency band. Accordingly, as a method of securing a broadband bandwidth for satisfying the requirement of a high data transmission rate in such a situation, a concept of a Carrier Aggregation (CA), in which respective dispersed bands are designed such that the respective bands satisfy a basic requirement under which the respective bands may be operated as independent systems, and multiple bands are grouped into one system, has been introduced.

In this case, a band capable of independently performing an operation is defined as a Component Carrier (CC). The UE 10 or the BS or cell 20 secures a transmission/reception broadband bandwidth in an uplink and a downlink by using multiple CCs, a system satisfying a service requirement of a next generation mobile communication system may be easily designed.

In this case, all CCs may be set such that they are compatible with use of only one band or carrier. It may be considered that one CC means one wireless communication band before the use of a CA.

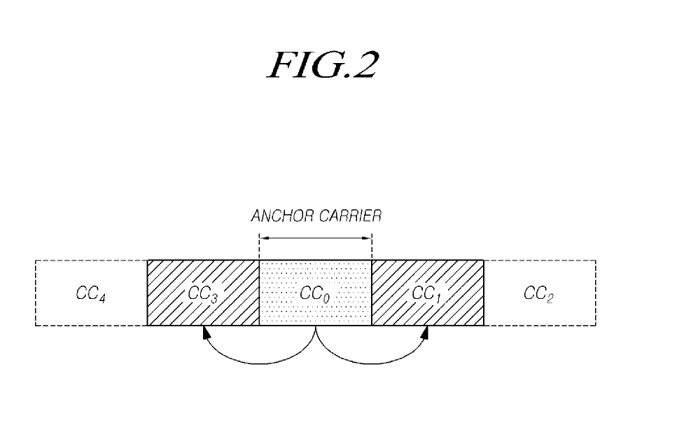

FIG. 2 is a system to which the present invention is applied, and illustrates a case in which 5 CCs having a band of 20 MHz in maximum are simultaneously used. FIG. 2 is an enlarged conceptual diagram illustrating a frequency in a CA environment.

In this case, the UE is generally capable of camping-on through all CCs in a wireless communication environment. The camp-on means a communicable state of the UE 10 in a specific frequency band through a process of, by the UE 10, forming synchronization with the BS 20 and receiving basic control information for communication with the BS through, a Master Information Block (MIB) including a Physical Broadcast Channel (PBCH) and a System Information Block (SIB) including a Physical Downlink Shared Channel (PDSCH). Especially, SIB2 includes a UL cell bandwidth, a random access parameter, and an uplink power control parameter. Accordingly, when the UE 10 camps on the BS 20, the UE 10 receives parameters for using a Random Access Channel (RACH).

RACH parameters may include other parameters related to the RACH, such as RACH scheduling information (time (sub frame) and frequency (physical resource units)), RACH sequences, access class restrictions, persistence values, how often RACH retransmissions must occur, and the number of times of allowable re-transmission, RACH power control parameters, and the like.

Further, the UE 10 may basically perform a random access to all CCs. Currently, there is a high probability in that the UE 10 randomly accesses a CC for an LTE which is highly is probable to be an anchor carrier in a CA environment.

When there are multiple CCs in the CA environment, a CC that is a reference becomes the aforementioned anchor carrier. That is, as illustrated in FIG. 2, an anchor CC serves as a reference notifying a carrier operated in a CA mode based on the anchor carrier.

In the transmission of CC information to the mobile communication terminal (UE) in a wireless communication system using multiple CCs according to embodiments of the present invention, the BS 20 determines the number of necessary CCs in a higher layer of layer L2 or higher, not a physical layer (L1) according to service requirement information transmitted to the BS 20 by each UE 10 and transmits the information on the determined number of necessary CCs to the UE 10, and the BS 20 inserts information on actual CC allocation in L1 control information and transmits the information.

Here, the higher layer of L2 or higher means a layer, such as layer L2 including a Medium Access Control (MAC) layer, a Radio Link Control (RLC) layer, a Packet Data Convergence Protocol (PDCP), and a Broadcast/Multicast Control (BMC) layer or layer L3 including a Radio Resource Control (RRC) layer, higher than the physical layer (layer L1).

The UE 10 receiving the aforementioned two types of information, i.e. the information on the number of necessary CCs and the information on the actual CC allocation, may configure CC information by combining the number of usable CCs transmitted from the higher layer of layer L2 or higher and the information on the actual CC allocation included in the is L1 control information.

In this case, a message used for the transmission of the information on the number of necessary CCs to each UE 10 may be an RRC message or a message of another control device. Otherwise, when the BS 20 transmits the information on the usable CCs of the UE 10 through system information, broadcasting, or other methods, the UE 10 may estimate the number of CCs according to the received information on the number of CCs.

When the BS 20 transmits the system information including the total number of CCs of a cell camped on by the UE 10, the UE 10 may set the total number of CCs according to a performance of the UE 10 and transfer information on the set total number of CCs to the BS 20.

In the meantime, when the UE receives the system information containing the information on the number of usable CCs only through the anchor carrier as a case in which the UE 10 transmits the system information on the usable CCs according to the performance of each UE 10, the UE 10 has been already aware of information on the anchor carrier for an initial to access and camps on a corresponding cell by using the information on the anchor carrier. Next, the UE 10 transfers the information on the performance of the UE 10 to the BS 20. Then, the BS 20 may set the number of CCs according to the performance of the UE 10 and the number of CCs less than that of CCs which are supportable by the UE 10 considering usable resources of the CCs within the cell, a compatibility of each CC with the UE 10, and a characteristic of each CC. In the meantime, system information on the CCs other than the set anchor carrier may be transmitted through a path for transmitting the system information on the anchor carrier.

In the meantime, when the UE 10 receives the system information through each CC, the UE 10 has been already aware of basic information on multiple CCs for the initial access. Accordingly, the UE 10 receives the system information on the respective CCs transmitted from the BS 20 by using the basic information. Next, the UE 10 sets all or a part of the total number of CCs included in the system information as the number of usable CCs based on the received system information and transfers information on the set number of CCs to the BS 20.

According to another embodiment of the present invention, a physical layer of the BS 20 may determine both the information on the number of usable CCs and the information on the actual CC allocation, generate resource setting information on the total CCs, insert the generated resource setting information in physical layer control information, and transmit the information to the UE 10.

Hereinafter, a characteristic of resource management of CCs and a method of transmitting information on the CCs according to the characteristic of the resource management according to an embodiment will be described.

As described above, since each CC is able to perform an operation as an independent system, the UE 10 may support a normal mobile communication service only with one CC in minimum and simultaneously support a mobile communication service by using multiple CCs. In this case, a method of the resource management for the CCs has the following characteristics, so that the method is necessary to be accessed in an aspect different from that of the existing mobile communication system.

1) The CC must be able to perform an operation as an independent system, so a minimally demanded bandwidth is wide.

2) Since frequency bands between the CCs are different, a change of a link performance between the respective CCs may be differently represented due to inconsistency of generated wave propagation characteristics.

Accordingly, it is necessary to consider the aforementioned two characteristics for the resource management in the unit of CCs.

A service requirement demanded in an application program of the UE 10 is generally changed in the unit of several seconds in minimum and several hours or longer in maximum. Accordingly, it is a rarely generated event that an additional CC is allocated so as to meet the service requirement of the UE 10 or the allocated CC is collected within a limit causing no problem in the service requirement. Accordingly, the definition of a new Downlink Control Information (DCI) field with 4 bits defined as an Active (non-anchor) Component Carrier Indicator (ACCI) in order to express a set of multiple CCs and the continuous insertion of information having little change according to a time in information transmitted in the unit of sub is frames, such as the PDCCH, of the defined DCI field generates an unnecessary overhead in limited PDCCH resources.

In contrary, a control device of a higher layer of layer L2 or higher may transmit both the information on the number of usable CCs and the information on the actual CC allocated to the UE 10. Although it is not limited to the embodiment of the preset invention, the actual performance of each UE 10 for the physical channel of each CC may be very rapidly changed according to a channel environment of the UE 10, such as a change of a distance between the UE 10 and the BS 20, a movement speed of the UE 10, and a movement of a neighboring object. A case where the control device of the higher layer of layer L2 or higher corresponds to the change of the performance of each UE 10 in real time may generate a performance deterioration due to a high delay compared to a response time of the physical channel and aggravate a signaling overhead in the higher layer of layer L2 or higher.

Accordingly, in order to efficiently respond to the problems, the higher layer of layer L2 or higher determines the entire radio resources so as to respond to the service requirement and transmits the corresponding information, and a scheduler controls actually allocated radio resources according to the physical channel environment and transmits information on the actually allocated radio resources as physical layer control information, so that the efficiency of the system may be increased.

Information on a final CC to be transferred to the UE 10 by the BS 20 is classified into information on the number of preferentially usable CCs and the information on the actual CC allocation. The control device of the higher layer of layer L2 or higher of the BS 20 may determine the information on the number of usable CCs and transmits the determined information to the corresponding UE 10 and the scheduler of the BS 20, insert information (information on the actual CC allocation) on a set of CCs selected in the scheduler based on the information on the number of usable CCs of each UE 10 in a format of physical layer resource control information containing physical layer control information of the scheduler for the corresponding UE 10, and transmit the information on the set of the CCs to the UE 10. Here, the information indicating the number of usable CCs is referred to as number indicating information, and information on the set of the CCs which is the information on the actual CC allocation is referred to as allocation indicating information.

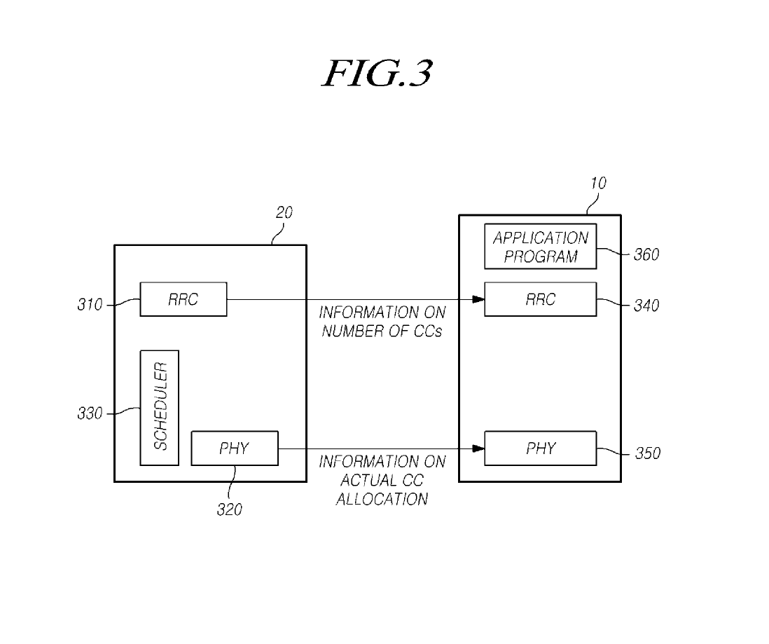

FIG. 3 is a layer diagram of the BS and the UE in the wireless communication system according to an embodiment of the present invention.

Referring to FIG. 3, the BS 20 of the wireless communication system according to the embodiment of the present invention includes an RRC layer 310 and a physical layer 320. The physical layer 320 includes a scheduler 330. In the meantime, the UE 20 includes an RRC layer 340, a physical layer 350, and an application program 360. Other layers may be included in the BS 20 and the UE 10, in addition to the aforementioned layers, as a matter of course, but they are omitted.

The RRC layer 310 of the BS 20 corresponds to the RRC layer 340 of the UE 10. Likewise, the physical layer 320 of the BS 20 corresponds to the physical layer 350 of the UE 10.

A control device of the RRC layer 310 of the BS 20 determines information on the number of usable CCs, and number indicating information that is the information on the number of usable CCs of the UE 10 is transferred from the RRC layer 310 of the BS 20 to the RRC layer 340 of the UE 10 through an RRC message. In this case, it has been already described that the message used for transmission of the information on the number of necessary CCs to each UE 10 is the RRC message, but it is not limited thereto, and may be another message of the control device.

In the meantime, the control device of the RRC layer 310 of the BS 20 inserts the allocation indicating information that is the information on the actual CC allocation selected in the scheduler 330 of the physical layer 320 of the BS 20 based on the information on the number of usable CCs of each UE 10 in a format of physical layer resource control information containing physical layer control information of the scheduler for the corresponding UE 10 and transmits the allocation indicating information to the physical layer 350 of the UE 10.

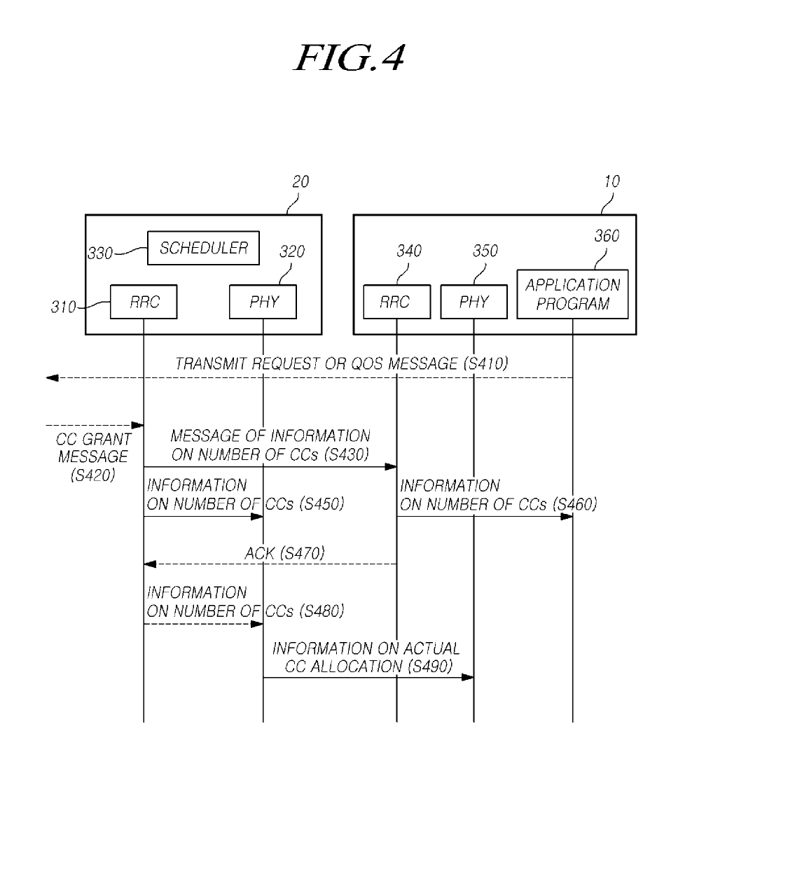

FIG. 4 is a flow diagram illustrating transmission of the information on the number of usable CCs and the information on the actual CC allocation from the BS to the UE according to the embodiment of the present invention.

Referring to FIGS. 3 and 4, a request for Quality of Service (QoS) information generated according to a service of the application program 360 of the UE 10 or additional radio resources is transferred to a specific control device (not shown) of the BS 20 capable of determining radio resource allocation (S410).

Next, a radio resource allocation control device (not shown) of the BS 20 generates the number indicating information that is the information on the number of usable CCs in response to the request for the QoS information on the corresponding UE 10 and the additional radio resource considering a performance of a link between the UE 10 and the BS 20, a current state of CC allocation of the BS 20, etc.

The number of usable CCs may be the number of CCs including the physical layer control information or the number of CCs including data, which the UE 10 has to receive, among the total number of CCs.

In this case, one of the control devices of existing layer L2 or higher may set the number of necessary CCs for support of the QoS of the UE 10. In this case, a transmission rate, a delay time, a demanded error rate, etc. among QoS requirements are considered in priority. In the meantime, one of the control devices of existing layer L2 or higher may include the scheduler.

When there is no control device capable of setting the number of necessary CCs for the support of the QoS of the UE 10 among the control devices of the existing layer of layer L2 or higher, a control device for controlling the number of usable CCs of each UE 10 may be newly defined and a corresponding control device may set the number of usable CCs.

A radio resource allocation detail for the corresponding UE 10 is transferred to the RRC layer 310 of the BS 20 through an additional CC grant message (S420). In the present embodiment, only information on the CC in the radio resource allocation detail may be considered.

Next, the RRC layer 310 of the BS 20 transmits the information on the number of usable CCs to the UE 10 (S430).

Specifically, the BS 20 may map the generated information on the number of usable CCs to the system information and transmit the mapped information to the UE 10. For example, in a method of mapping the generated information on the number of usable CCs to the system information, the generated information on the number of usable CCs may be mapped to a format of SIB1 or SIB2 that is the system information or to a format of another system information. Further, the method of mapping the generated information on the number of usable CCs to the system information may use the PDSCH as the physical layer channel for transmission of data of the physical layer or another physical layer channel.

In another method of mapping the generated information on the number of usable CCs to the system information, an identifier may be inserted in the generated information on the number of usable CCs and the generated information on the number of usable CCs including the identifier may be mapped in a shared channel set for data transmission. For example, the shared channel for the data transmission may be a DL-SCH or another data shared channel. In this case, the physical layer channel for the transmission of the data of the physical layer may be the PDSCH or another physical layer channel.

Next, the RRC layer 340 of the UE 10 transfers information on the number of currently usable CCs to the physical layer 350 (S460). In this event, the UE 10 may transfer an ACK for corresponding RRC information to the BS 20. However, the UE 10 may not transfer the ACK for the corresponding RRC information to the BS 20.

In this case, when the UE 10 does not transfer the ACK for the RRC information of the corresponding UE 10 to the BS 20, the RRC layer 310 of the BS 20 transmits the information on the number of usable CCs of the corresponding UE 10 to the scheduler 330 immediately or after a predetermined time (S450).

However, when the BS 20 receives the ACK for the RRC information of the corresponding UE 10, the RRC 310 of the BS 20 transmits the information on the number of usable CCs of the corresponding UE 10 to the scheduler 330 directly following the reception of the ACK (S480).

Next, the scheduler 330 of the BS 20 selects CCs equivalent to the number of necessary CCs received from the RRC 310 of the BS 20 considering a use rate of the respective CCs within a current cell, a performance of a link with the UE 10, etc., generates information on an actual CC allocation indicating the selected CCs, selects a format of the physical layer control information to which the generated information on the actual CC allocation may be inserted, and transmits the information on the actual CC allocation to the UE 10 (S490).

The UE 10 configures its final CC information by combining the information on the number of necessary CCs transferred to the physical layer 350 from the RRC 340 of the UE 10 and the information on the actual CC allocation included in the received physical layer control information, and receives information transmitted through the CCs allocated to the UE 10 itself based on the configured final CC information.

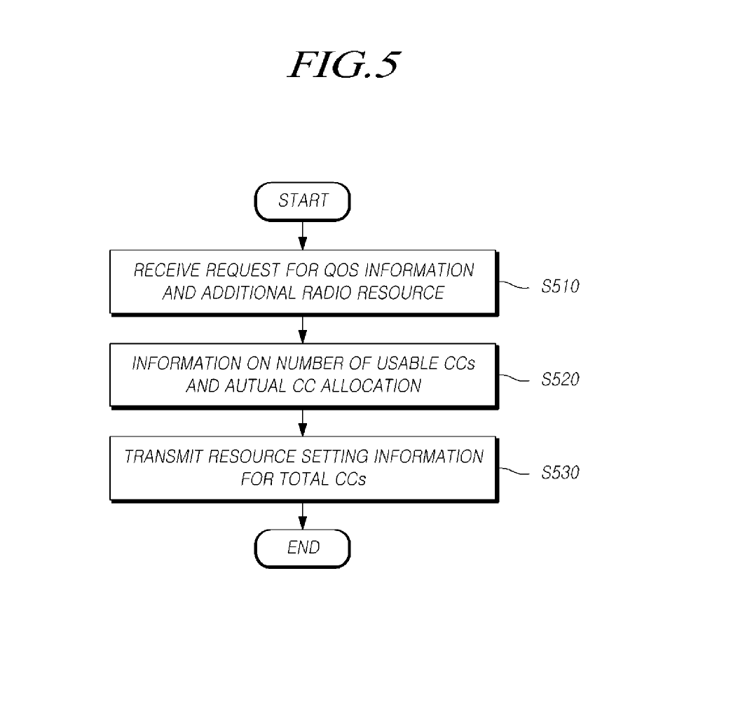

Contrary to the above embodiment, when the scheduler 330 of the BS 20 determines both the information on the number of usable CCs and the information on the actual CC allocation, the scheduler 330 of the BS 20 may generate resource setting information for all CCs, select a format of the physical layer control information, in which the generated resource setting information may be inserted, and transmit the resource setting information to the UE 10, which will be described with reference to FIG. 5 in detail.

FIG. 5 is a flow chart illustrating a method of transmitting CC information according to another embodiment of the present invention.

Referring to FIG. 5, the BS 20 first receives a request for QoS information and additional radio resources generated according to a service by the application program 360 of the UE 10 (S510).

Next, the scheduler 330 of the BS 20 determines information on the number of usable CCs and information on the actual CC allocation considering a performance of a link between the UE 10 and the BS 20, a current state of CC allocation of the BS 20 with respect to the request for the QoS information or the additional radio resource from the corresponding UE 10 (S520).

Specifically, when the scheduler 330 sets the information on the number of usable CCs, the scheduler 330 may map the information on the number of usable CCs to physical channel L1. For example, the PDCCH may serve as physical channel L1 for data transmission, and other channels may serve as physical channel L1.

Next, the scheduler 330 of the BS 20 generates resource setting information for all CCs, selects a format of physical layer control information, in which the generated resource setting information may be inserted, and transmits the resource setting information to the UE 10 (S530). In this case, the scheduler 330 of the BS 20 may independently set the information on the number of usable CCs and the information on the actual CC allocation, define the information on the number of usable CCs and the information on the actual CC allocation as information fields of the physical layer control information, respectively, and transmit the information on the number of usable CCs and the information on the actual CC allocation.

In the meantime, when the information on the number of usable CCs is changed, the scheduler 330 of the BS 20 may combine the information on the number of usable CCs and the information on the actual CC allocation, set the combined information on the number of usable CCs and information on the actual CC allocation as one field, and transmit the information. However, when the information on the number of usable CCs is not changed, the scheduler 330 of the BS 20 may transmit the information on the number of usable CCs and the information on the actual CC allocation by using an information field defined only with the information on the actual CC allocation.

As described above with reference to FIG. 4, the BS 20 may determine the information on the number of necessary CCs in the higher layer of layer L2 or higher, not in the physical layer (L1), according to information on service requirements transmitted to the BS 20 by each UE 10, and transmit the determined information on the number of necessary CCs to the UE 10. Further, the BS 20 may transmit the information on the actual CC allocation by inserting the information on the actual CC allocation in the physical layer control information. Further, as described above with reference to FIG. 5, the scheduler 330 of the BS 20 may determine both the information on the number of usable CCs and the information on the actual CC allocation, generate the resource setting information for all CCs, select a format of the physical layer control information, in which the generated resource setting information may be inserted, and transmit the resource setting information to the UE 10.

A method of generating the information on the actual CC allocation will be described below in detail. First, the following items are assumed, but the method is not limited thereto.

1) The anchor carrier allocated to each UE 10 is always used. Accordingly, the information on the actual CC allocation is limited to contents of the CCs, other than the anchor carrier.

2) A CC number may be set such that an anchor carrier number is 0, and orders of the remaining CC numbers may be logically set regardless of physical positions of the CCs.

3) A corresponding logical CC number is determined when an anchor carrier is first set, and is not changed after the determination.

4) The CC numbers may be the same or independently different in all UEs 10 within the cell.

5) The number of all CCs is equal to or smaller than 5.

The method of generating the information on the actual CC allocation may be variously applied according to the number of usable CCs and an allocation method (K CCs are always allocated or 1 through K CCs are allocated) of the actually allocated CCs. When only k CCs are used among n usable CCs, the maximum number of cases may be obtained as ₙCₖ through the application of a combination calculation to permutation and combination.

ₙCₖ Formula 1

In Formula 1, n has a maximum value which is smaller than the total number of CCs by 1, and may be applied to an embodiment using it as information for allocation of the CCs other than the anchor carrier. Accordingly, when the total number of CCs is 5, n may be equal to or smaller than 4. N, which is the number indicating information indicating the number of usable CCs, may be transmitted in a layer, such as layer L3 (RRC), higher than the physical layer.

Hereinafter, an example of a configuration of the information on the number of usable CCs and the information on the actual CC allocation will be described below. Tables 1 through 10, which are embodiments of the allocation indicating information, represent each bit information and information on a set (or combination) of CCs indicated by corresponding bit information, and the information may also be transmitted in a layer, such as layer L3 (RRC), higher than the physical layer according to the embodiment of the present invention.

The UE and the BS may share a relation between the allocation indicating information and the information on the CCs as illustrated in Tables 1 through 10, and a CC in a layer, such as layer L3 (RRC), higher than the physical layer. The information may be configured so as not to be changed once it is set.

When the number of usable CCs is 0, Downlink Control Information (DCI) including no information field for the actual CC allocation is transmitted. When the number of usable CCs is 1, the information on the actual CC allocation may be transmitted by using 2 bits as illustrated in Table 1. In Table 1, n is 4 and k is 1, and 4 types, ₄C₁, of bit information may be generated by Formula 1. The information on the actual CC allocation may include information having one element. The UE equipment may identify the CCs included in the set of the CCs through the bit information.

TABLE 1

| Information on actual CC allocation | Bit information |
|---|---|
| CC No. 1 | 00 |
| CC No. 2 | 01 |
| CC No. 3 | 10 |
| CC No. 4 | 11 |

When the number of usable CCs is 2, information on the actual CC allocation may be transmitted by using 3 bits as illustrated in Table 2. In Table 2, n is 4 and k is 2, and 6 types, ₄C₂, of bit information may be generated by Formula 1. The information on the actual CC allocation may include information having two elements. When the UE receives “001” that is the allocation indicating information, it may be identified that CC No. 1 and CC No. 3 are actually allocated.

TABLE 2

| Information on actual CC allocation | Bit information |
|---|---|
| CC Nos. 1 and 2 | 000 |
| CC Nos. 1 and 3 | 001 |
| CC Nos. 1 and 4 | 010 |
| CC Nos. 2 and 3 | 011 |
| CC Nos. 2 and 4 | 100 |
| CC Nos. 3 and 4 | 101 |
| Reserved | 110 |
| Reserved | 111 |

Table 2 represents the total number of cases using two CCs among four CCs, but the BS and the UE may use only a part of the total number of cases. Further, a length of bits allocated to bit information may be reduced as represented in Tables 3 to 5. The length of the bits may be variously applied depending on a property of the CC operated in the BS. The UE may identify the set of the actually allocated CCs through the bit information, so that when the number of cases of the combinations of the CCs is reduced, a length of bits used in the bit information may also be decreased.

When the number of usable CCs is two, the information on the actual CC allocation as represented in one of Tables 3 to 5 may be transmitted by using two bits.

TABLE 3

| Information on actual CC allocation | Bit information |
|---|---|
| CC Nos. 1 and 4 | 00 |
| CC Nos. 2 and 3 | 01 |
| CC Nos. 1 and 2 | 10 |
| CC Nos. 3 and 4 | 11 |

TABLE 4

| Information on actual CC allocation | Bit information |
|---|---|
| CC Nos. 1 and 3 | 00 |
| CC Nos. 2 and 4 | 01 |
| CC Nos. 1 and 2 | 10 |
| CC Nos. 3 and 4 | 11 |

TABLE 5

| Information on actual CC allocation | Bit information |
|---|---|
| CC Nos. 1 and 3 | 00 |
| CC Nos. 2 and 4 | 01 |
| CC Nos. 1 and 4 | 10 |
| CC Nos. 2 and 3 | 11 |

One of the aforementioned examples may be selected and permanently used, and information indicating information to be used among the aforementioned examples may be transmitted as a control device parameter of layer L3 (RRC) and one of the information may be variably selected and semi-statically used. In the meantime, the information on the actual CC allocation as represented in Table 6 may be transmitted by using variable bits (1, 2 bits).

TABLE 6

| Information on actual CC allocation | Bit information |
|---|---|
| CC Nos. 1 and 2 | 0 |
| CC Nos. 1 and 3 | 1 |
| CC Nos. 1 and 4 | 00 |
| CC Nos. 2 and 3 | 01 |
| CC Nos. 2 and 4 | 10 |
| CC Nos. 3 and 4 | 11 |

When the number of usable CCs is 3, the information on the actual CC allocation as represented in Table 7 may be transmitted by using two bits. That is, when three CCs among the four CCs are used, four types, ₄C₃, of bit information may be generated according to aforementioned Formula 1.

TABLE 7

| Information on actual CC allocation | Bit information |
|---|---|
| CC Nos. 1, 2, and 3 | 00 |
| CC Nos. 1, 3, and 4 | 01 |
| CC Nos. 1, 2, and 4 | 10 |
| CC Nos. 2, 3, and 4 | 11 |

When the number of usable CCs is 4, the DCI including no information field for the actual CC allocation may be transmitted.

As illustrated in Tables 1 to 7, the total number of CCs is 5, one of the five CCs is the anchor carrier, and the remaining four CCs are allocable. Herein, the BS may select zero through four CCs and allocate the selected CC(s) to the UE. The number of cases for the above case is represented as following. That is, the BS allocates K CCs or less among n usable CCs, a maximum value of the number of cases may be calculated by Formula 2.

$${\sum }_{i = 0}^{k} {}_{n}^{}{C}{}_{i}^{} \qquad Formula 2$$

Accordingly, when n is 4 and k is 4, the maximum value of the number of cases with the application of Formula 2 may be calculated as expressed in Formula 3.

$$\begin{matrix}{\sum }_{i = 0}^{4} {}_{4}^{}{C}{}_{i}^{} = {}_{4}^{}{C}{}_{0}^{} + {}_{4}^{}{C}{}_{1}^{} + {}_{4}^{}{C}{}_{2}^{} + {}_{4}^{}{C}{}_{3}^{} + {}_{4}^{}{C}{}_{4}^{} \\ = 1 + 4 + 6 + 4 + 1 \\ = 16\end{matrix} \qquad Formula 3$$

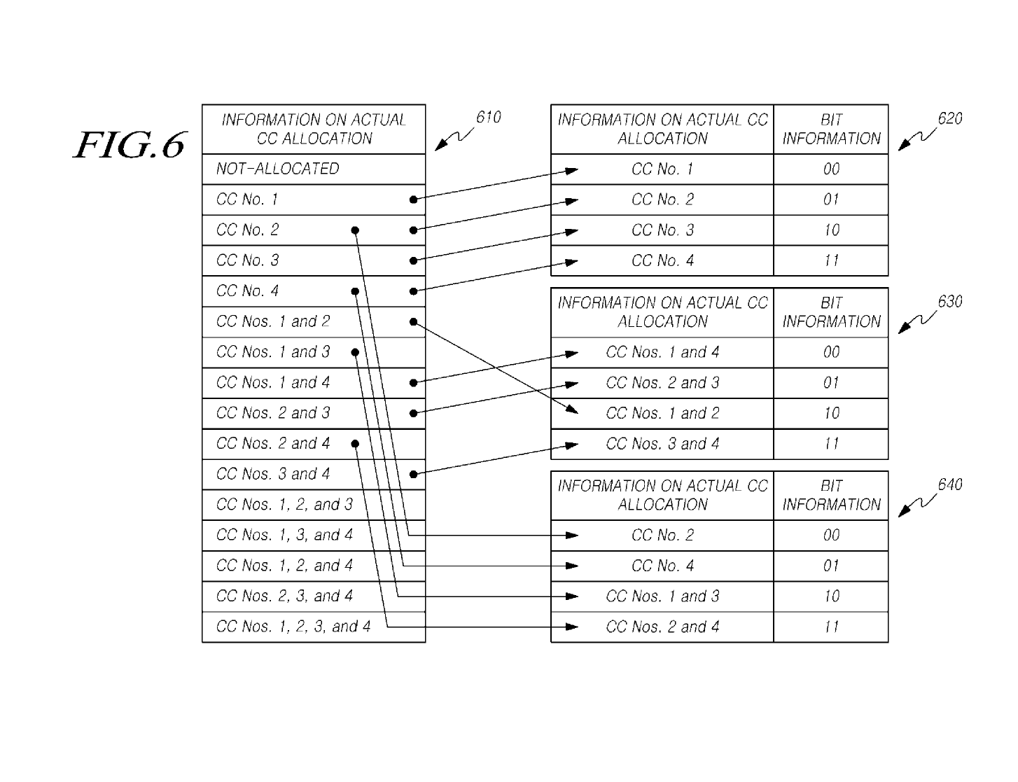

FIG. 6 is a diagram illustrating sets of bit information and allocated CCs according to an embodiment of the present invention.

Referring to FIG. 6, reference number 610 indicates 16 sets of the number of cases calculated by Formula 3. Reference number 610 is obtained by combining Tables 1, 2, and 7. 16 types of bit information, which is the allocation indicating information according to the embodiment, are necessary in order to indicate all sets indicated by reference number 610, and a maximum length of bits allocable to the bit information is 4 bits.

However, as described above, it is not necessary to provide all of the number of cases as the bit information because the BS and the UE make a rearrangement and use only necessary information while sharing the information through a higher layer, such as layer L2, so that the number of cases of the used bit information may be reduced.

For example, when only one CC is used as represented in Table 1, a total of four types of bit information with 2 bits may be represented as denoted by reference number 620. Further, when the BS 20 selects a part of sets including respective two CCs and allocates the sets of the CCs as represented in Table 3, a total of four types of bit information with 2 bits may be represented as denoted by reference number 630.

In the meantime, in a case where the number of usable CCs is not designated as one or two, CC number 2 or 4 may be allocated when one CC is used, and CC numbers 1 and 3 and CC numbers 2 and 4 may be allocated when two CCs are used, as indicated by reference number 640. This case may be applied to a case in which the transmission efficiency is decreased when CC numbers 1 and 2 (or CC numbers 3 and 4) are used together according to a physical characteristic. When the sets of the CCs to be used for the actual allocation among the 16 sets indicated by reference number 610 are determined, the bit information indicating the determined set is determined. When 8 types of information in maximum are selected in the information of reference number 610 and configured as Table 620, 630, or 640, and when the UE and the BS share the configured information, the information on the actual CC allocation may be indicated by bit information of 3 bits.

Accordingly, through the application of Formula 2, a length of bits for indicating maximally usable bit information according to values of n and k may be calculated as Formula 4.

$${log}_{2} ( {\sum }_{l = 0}^{k} {}_{n}^{}{C}{}_{i}^{} ) \qquad Formula 4$$

When the total number of CCs is 4, the anchor carrier is set according to the same method as that of the case where the total number of component sub-carriers is 5 and the remaining three CCs are defined as sub carriers. When the total number of CCs is 4, n is 3 when the anchor carrier is excluded.

When the number of usable CCs is 0, the DCI including no information field for the actual CC allocation may be transmitted. When the number of usable CCs is 1, the information on the actual CC allocation as represented in Table 8 may be transmitted by using two bits. That is, when one CC among the three CCs is used, n is 3 and k is 1, and three types, ₃C₁, of bit information may be generated according to aforementioned Formula 1.

TABLE 8

| Information on actual CC allocation | Bit information |
|---|---|
| CC No. 1 | 00 |
| CC No. 2 | 01 |
| CC No. 3 | 10 |
| Reserved | 11 |

When the number of usable CCs is 2, the information on the actual CC allocation as represented in Table 9 may be transmitted by using two bits. That is, when two CCs among the three CCs are used, n is 3 and k is 2, and three types, ₃C₂, of bit information may be generated according to aforementioned Formula 1.

TABLE 9

| Information on actual CC allocation | Bit information |
|---|---|
| CC Nos. 1 and 2 | 00 |
| CC Nos. 2 and 3 | 01 |
| CC Nos. 1 and 3 | 10 |
| Reserved | 11 |

When the number of usable CCs is 3, the DCI including no information field for the actual CC allocation may be transmitted.

When the total number of component sub-carriers is 3, the anchor carrier is set according to the same method as that of the case where the total number of component sub-carriers is 5 and the remaining two component sub-carriers are defined as component sub-carriers.

When the number of usable CCs is 0 and 2, the DCI including no information field for the actual CC allocation may be transmitted.

When the number of usable CCs is 1, the information on the actual CC allocation as represented in Table 10 may be transmitted by using one bit. That is, when one CC among the two CCs is used, n is 2 and k is 1, and two types, ₂C₁, of bit information may be generated according to aforementioned Formula 1.

TABLE 10

| Information on actual CC allocation | Bit information |
|---|---|
| CC No. 1 | 0 |
| CC No. 2 | 1 |

When the total number of component sub carriers is 2, the anchor carrier is set according to the same method as that of the case where the total number of component sub carriers is 5. Since the number of CCs is 0 or 1, the scheduler may not set the information field for the actual CC allocation.

In the aforementioned examples, the information on the actual CC allocation and the bit information indicating the information on the actual CC allocation may be changed and set at the time of initially configuring the wireless system.

In the meantime, in a case where it is desired to transmit the information on the number of usable CCs through physical layer L1, the information on the number of usable CCs may be generated as Table 11 when the total number of CCs is 5, as Table 12 when the total number of CCs is 4, as Table 13 when the total number of CCs is 3, and as Table 14 when the total number of CCs is 2. The bit information represented in Tables 11 to 14 are the number indicating information indicating the number of usable CCs according to the embodiment.

TABLE 11

| Information on actual CC allocation | Bit information |
|---|---|
| One CC | 00 |
| Two CCs | 01 |
| Three CCs | 10 |
| Four CCs | 11 |

TABLE 12

| Information on actual CC allocation | Bit information |
|---|---|
| One CC | 00 |
| Two CCs | 01 |
| Three CC | 10 |
| Reserved | 11 |

TABLE 13

| Information on actual CC allocation | Bit information |
|---|---|
| One CC | 0 |
| Two CCs | 1 |

TABLE 14

| Information on actual CC allocation | Bit information |
|---|---|
| One CC | 0 |
| Reserved | 1 |

The allocation of an additional CC so as to meet the service requirements for an application program of the UE 10 or the collection of the allocated CC within a range causing no problem to service requirements is a rarely generated event.

Accordingly, according to the aforementioned embodiments, since the BS 20 determines the information on the number of necessary CCs in a higher layer of layer L2 or higher, not in the physical layer (L1), and transmits the determined information on the number of necessary CCs to the UE 10, or the scheduler 330 of the BS 20 determines both the information on the number of usable CCs and the information on the actual CC allocation and transmits the determined information to the UE 10, the present invention may efficiently control the set of the CCs for each UE by using a smaller number of bits for the physical layer control information. Further, the generated overhead of the higher layer of layer L2 or higher may be minimized.

Even if it was described above that all of the components of an embodiment of the present invention are coupled as a single unit or coupled to be operated as a single unit, the is present invention is not necessarily limited to such an embodiment. That is, among the components, one or more components may be selectively coupled to be operated as one or more units. In addition, although each of the components may be implemented as an independent hardware, some or all of the components may be selectively combined with each other, so that they can be implemented as a computer program having one or more program modules for executing some or all of the functions combined in one or more hardwares. Codes and code segments forming the computer program can be easily conceived by an ordinarily skilled person in the technical field of the present invention. Such a computer program may implement the embodiments of the present invention by being stored in a computer readable storage medium, and being read and executed by a computer. A magnetic recording medium, an optical recording medium, a carrier wave medium, or the like may be employed as the storage medium.

In addition, since terms, such as “including,” “comprising,” and “having” mean that one or more corresponding components may exist unless they are specifically described to the contrary, it shall be construed that one or more other components can be included. All of the terminologies containing one or more technical or scientific terminologies have the same meanings that persons skilled in the art understand ordinarily unless they are not defined otherwise. A term ordinarily used like that defined by a dictionary shall be construed that it has a meaning equal to that in the context of a related description, and shall not be construed in an ideal or excessively formal meaning unless it is clearly defined in the present specification.

Although a preferred embodiment of the present invention has been described for illustrative purposes, those skilled in the art will appreciate that various modifications, additions and substitutions are possible, without departing from the scope and spirit of the invention as disclosed in the accompanying claims. Therefore, the embodiments disclosed in the present invention are intended to illustrate the scope of the technical idea of the present invention, and the scope of the present invention is not limited by the embodiment. The scope of the present invention shall be construed on the basis of the accompanying claims in such a manner that all of the technical ideas included within the scope equivalent to the claims belong to the present invention.

1. A method of transmitting Component Carrier (CC) information in a wireless communication system, the method comprising:
transmitting information on a number of usable CCs of a user equipment to the user equipment, the information on the number of usable CCs being determined in a Radio Resource Control (RRC) layer; and
inserting information on CC allocation in physical layer resource control information based on the information on the number of usable CCs of the user equipment and transmitting the information on the CC allocation to the user equipment.

2. The method as claimed in claim 1, further comprising determining the information on the number of usable CCs with respect to a request for information on a Quality of Service (QoS) or an additional radio resource from the user equipment considering at least one of a performance of a link between the user equipment and a base station and a state of CC allocation of the base station by the RRC layer.

3. The method as claimed in claim 1, wherein in transmitting of the information on the number of usable CCs to the user equipment, the information on the number of usable CCs of the user equipment is mapped to system information to be transmitted.

4. The method as claimed in claim 1, wherein transmitting of the information on the CC allocation to the user equipment comprises selecting a specific CC considering at least one of a use rate of the CC within a cell and a performance of a link between the user equipment and a base station and generating CC information for the selected CC by the base station.

5. The method as claimed in claim 1, wherein transmitting of the information on the CC allocation to the user equipment comprises transmitting the information on the CC allocation to the user equipment by using 3 bits or less.

6. The method as claimed in claim 1, wherein transmitting of the information on the CC allocation to the user equipment is more frequently performed than transmitting of the information on the number of usable CCs to the user equipment.

7. A method of transmitting Component Carrier (CC) information in a wireless communication system, the method comprising:
determining information on a number of usable CCs of a user equipment and information on CC allocation for the user equipment considering the number of usable CCs by a scheduler; and
inserting the determined information on the number of usable CCs and the determined information on the CC allocation in physical layer resource control information and transmitting the information on the number of usable CCs and the information on the CC allocation to the user equipment by the scheduler.

8. The method as claimed in claim 7, wherein in transmitting of the information on the number of usable CCs and the information on the CC allocation to the user equipment, the information on the number of usable CCs and the information on the CC allocation are inserted in an independently set information field of physical layer control information, respectively, to be transmitted.

9. The method as claimed in claim 8, further comprising, when the information on the number of usable CCs is changed, setting changed information on the number of usable CCs and the information on the CC allocation in one field and transmitting the changed information on the number of usable CCs and the information on the CC allocation.

10. The method as claimed in claim 7, further comprising, when the information on the number of usable CCs is not changed, inserting only the information on the CC allocation in the set information field of the physical layer control information and transmitting the information on the CC allocation.

11. A wireless communication apparatus, comprising:
a Radio Resource Control (RRC) layer for determining information on a number of usable Component Carriers (CCs) of a user equipment and transmitting the determined information on the number of usable CCs to the user equipment; and
a physical layer for inserting information on CC allocation in physical layer resource control information based on the information on the number of usable CCs of the user equipment and transmitting the information on the CC allocation to the user equipment.

12. The wireless communication apparatus as claimed in claim 11, wherein the RRC layer determines the information on the number of usable CCs considering at least one of a performance of a link between the user equipment and a base station and a condition of CC allocation of the base station with respect to a request for information on a Quality of Service (QoS) or an additional radio resource from the user equipment.

13. The wireless communication apparatus as claimed in claim 11, wherein the RRC layer maps the information on the number of usable CCs of the user equipment to system information and transmits the mapped information to the user equipment.

14. The wireless communication apparatus as claimed in claim 11, wherein the physical layer selects a specific CC considering at least one of a use rate of each CC within a cell and a performance of a link between the user equipment and a base station and generates the selected CC as information on the CC allocation.

15. The wireless communication apparatus as claimed in claim 11, wherein the physical layer transmits the information on the CC allocation to the user equipment by using a bit smaller than 3 bits.

16. A method of transmitting Component Carrier (CC) information, comprising:
by a base station,
calculating a number of usable CCs of a user equipment;
transmitting number indicating information indicating the number of usable CCS to the user equipment;
selecting a CC actually allocated to the user equipment among the usable CCs; and
transmitting allocation indicating information indicating the selected actually allocated CC.

17. The method as claimed in claim 16, wherein transmitting of the number indicating information comprises transmitting the number indicating information through a Radio Resource Control (RRC) message in an RRC layer.

18. The method as claimed in claim 16, wherein transmitting of the allocation indicating information comprises inserting the allocation indicating information in a format of physical layer resource control information and transmitting the allocation indicating information in a physical layer.

19. The method as claimed in claim 16, wherein the number indicating information contains bit information indicating a number of one or more CCs.

20. The method as claimed in claim 16, wherein the allocation indicating information contains bit information indicating information on one or more actually allocated CCs.

21. The method as claimed in claim 20, wherein the bit information includes a variable bit.

22. The method as claimed in claim 16, wherein the number of usable CCs excludes a number of anchor carriers.

23. The method as claimed in claim 16, wherein calculating of the number of usable CCs comprises determining the number of usable CCs considering at least one of a performance of a link between the user equipment and the base station and a current state of CC allocation of the base station.

24. A method of receiving Component Carrier (CC) information, comprising:
by a user equipment,
receiving number indicating information indicating a number of usable CCs from a base station; and
receiving allocation indicating information indicating an actually allocated CC among the usable CCs from the base station.

25. The method as claimed in claim 24, wherein receiving of the number indicating information comprises receiving the number indicating information which is transmitted through a Radio Resource Control (RRC) message in an RRC layer.

26. The method as claimed in claim 24, wherein receiving of the allocation indicating information comprises receiving the allocation indicating information which is transmitted while being included in a format of physical layer resource control information from a physical layer.

27. The method as claimed in claim 24, wherein the number indicating information contains bit information indicating a number of one or more CCs.

28. The method as claimed in claim 24, wherein the allocation indicating information contains bit information indicating information on a number of one or more actually allocated CCs.

29. The method as claimed in claim 28, wherein the bit information includes a variable bit.

30. The method as claimed in claim 24, wherein the number of usable CCs excludes a number of anchor carriers.

31. The method as claimed in claim 24, wherein the number of usable CCs is calculated considering at least one of a performance of a link between the user equipment and a base station and a current state of CC allocation of the base station.

32. A base station, comprising:
a higher layer controller for calculating a number of usable Component Carriers (CCs) of a user equipment and transmitting number indicating information indicating the number of usable CCs to the user equipment;
a scheduler for selecting a CC actually allocated to the user equipment; and
a physical layer controller for transmitting allocation indicating information indicating the actually allocated CC to the user equipment.

33. The base station as claimed in claim 32, wherein the higher layer controller is a Radio Resource Control (RRC) layer controller, and transmits the number indicating information through an RRC message.

34. The base station as claimed in claim 32, wherein the physical layer controller inserts the allocation indicating information in a format of physical layer resource control information and transmits the allocation indicating information.

35. The base station as claimed in claim 32, wherein the number indicating information contains bit information indicating information on a number of one or more CCs.

36. The base station as claimed in claim 32, wherein the allocation indicating information contains bit information indicating a number of one or more actually allocated CCs.

37. The base station as claimed in claim 36, wherein the bit information includes a variable bit.

38. The base station as claimed in claim 32, wherein the number of usable CCs excludes a number of anchor carriers.

39. The base station as claimed in claim 32, wherein the higher layer controller determines the number of usable CCs considering at least one of a performance of a link between the user equipment and the base station and a current state of CC allocation of the base station.

40. A user equipment, comprising:
a higher layer controller for receiving number indicating information indicating a number of usable Component Carriers (CCs) from a base station; and
a physical layer controller for receiving allocation indicating information indicating an actually allocated CC among the usable CCs from the base station.

41. The user equipment as claimed in claim 40, wherein the higher layer controller receives the number indicating information transmitted through aRadio Resource Control (RRC) message from an RRC layer.

42. The user equipment as claimed in claim 40, wherein the physical layer controller receives the allocation indicating information which is transmitted while being included in a format of physical layer resource control information from a physical layer.

43. The user equipment as claimed in claim 40, wherein the number indicating information contains bit information indicating a number of one or more CCs.

44. The user equipment as claimed in claim 40, wherein the allocation indicating information contains bit information indicating information on a number of one or more actually allocated CCs.

45. The user equipment as claimed in claim 44, wherein the bit information includes a variable bit.

46. The user equipment as claimed in claim 40, wherein the number of usable CCs excludes a number of anchor carriers.

47. The user equipment as claimed in claim 40, wherein the number of usable CCs is calculated considering at least one of a performance of a link between the user equipment and the base station and a current state of CC allocation of the base station.
